(19) United States
(12) Patent Application Publication
(10) Pub. No.: US 2017/0193767 A1
(43) Pub. Date: Jul. 6, 2017

(54) HAPTIC COMMUNICATION DEVICE AND SYSTEM FOR TRANSMITTING HAPTIC INTERACTION

(71) Applicant: Parihug, Cleveland, OH (US)

(72) Inventors: Xyla Foxlin, Cleveland, OH (US); Thomas Hayes, Lakewood, OH (US)

(21) Appl. No.: 15/393,782

(22) Filed: Dec. 29, 2016

Related U.S. Application Data
(60) Provisional application No. 62/272,785, filed on Dec. 30, 2015.

(51) Int. Cl. G08B 6/00

(52) U.S. Cl. CPC G08B 6/00

(57) ABSTRACT

A haptic communication device and system of remote haptic communication is provided. The haptic communication device may be in the form of a plush toy. The haptic communication device contains a communication apparatus. The communication apparatus includes a pressure sensor potted within a mass of pressure transmitting material and electrically connected to a circuit board. The circuit board may also be electrically connected to other components, such as a microprocessor and a Wi-Fi component. The communication apparatus is capable of accurately detecting a compression force from a first user and is capable of transmitting signals indicating compression to a server over a communication network. A second haptic communication device may receive signals from the server indicating that a first haptic communication device was compressed. The second haptic communication device may then effectuate a haptic response, felt by a second user of the second haptic communication device.

### RELATED APPLICATION

This application claims priority from U.S. Provisional Application No. 62/272,785, filed Dec. 30, 2015, the subject matter of which is incorporated herein by reference in its entirety.

### TECHNICAL FIELD

This disclosure relates to haptic communication devices and, more particularly, to a haptic communication toy capable of inducing a haptic response in another haptic communication device.

### BACKGROUND

Toys, particularly stuffed animals, have long been used as a means of providing comfort and a sense of companionship to a user. Users often form a sense of emotional attachment to their favorite stuffed animal as they would another human being. This sense of emotional attachment is often heightened when a stuffed animal is capable of reacting, in some way or another, to a user's contact, communication, or manipulation of it. Such conventional interactive stuffed animals include ones that can speak, move, light up, or play music, among other things, upon some form of actuation or manipulation by the user. Emotional enrichment may be further attained when such interactive toys are programmable to convey responses mimicking or simulating interaction with another human individual, instead of just a toy.

### SUMMARY

In an aspect, a haptic communication device is provided. The haptic communication device includes a flexible outer shell. The haptic communication device includes a circuit board wholly encased within the flexible outer shell, which has at least one pressure sensor located on and electrically connected to a first surface of the circuit board. A mass of pressure transmitting material is wholly encased within the flexible outer shell and is at least partially attached to the first surface of the circuit board. The mass of pressure transmitting material extends from the first surface of the circuit board and at least partially encases the at least one pressure sensor. At least one microprocessor is wholly encased within the flexible outer shell and is electrically connected to the circuit board. At least one haptic response motor is wholly encased within the flexible outer shell and is electrically connected to the circuit board.

In an aspect, a system of haptic communication is provided. The system includes at least two haptic communication devices. Each haptic communication device includes a flexible outer shell. Each haptic communication device includes a circuit board wholly encased within the flexible outer shell. At least one pressure sensor is located on and electrically connected to a first surface of the circuit board. A mass of pressure transmitting material is wholly encased within the flexible outer shell and is at least partially attached to the first surface of the circuit board. The mass of pressure transmitting material extends from the first surface of the circuit board and at least partially encases the at least one pressure sensor. At least one microprocessor is wholly encased within the flexible outer shell and is electrically connected to the circuit board. At least one haptic response motor is wholly encased within the flexible outer shell and is electrically connected to the circuit board. A server and a communication network are configured to transmit signals between at least one microprocessor of each of the at least two haptic communication devices and the server.

In an aspect, a method of providing a haptic communication device is provided. The method includes providing a circuit board that is electrically connected to at least one pressure sensor, at least one microprocessor, and at least one haptic response motor. The at least one pressure sensor is located on a first surface of the circuit board. The first surface of the circuit board is potted into a mass of silicone material in fluid form. The pressure sensor is at least partially encapsulated by the mass of silicone material. The mass of silicone material is solidified. The circuit board is attached to a housing base. The solidified mass of silicone material and circuit board is secured within the housing base by attaching a retainer ring around the mass and into engagement with the housing base. The circuit board, mass of silicone material, and housing base are placed within a flexible outer shell. The flexible outer shell is at least partially filled with a stuffing material to at least partially surround the circuit board, mass of silicone material, and housing base with stuffing material within the flexible outer shell.

### BRIEF DESCRIPTION OF THE DRAWINGS

For a better understanding, reference may be made to the accompanying drawings, in which:

FIG. 1 is a schematic perspective view of an aspect of the present invention;

FIG. 2A is a schematic bottom view of the aspect of FIG. 1;

FIG. 2B is a schematic top view of the aspect of FIG. 1;

FIG. 3 is a schematic front view of an example use environment for the aspect of FIG. 1;

FIG. 4 is a flowchart of an example sequence of use of the aspect of FIG. 1;

FIG. 5 is a schematic diagram of a system including the aspect of FIG. 1;

FIG. 6 is a schematic exploded view of the aspect of FIG. 1; and

FIG. 7 is a schematic perspective view of the aspect of FIG. 1.

### DESCRIPTION OF ASPECTS OF THE DISCLOSURE

Unless defined otherwise, all technical and scientific terms used herein have the same meaning as is commonly understood by one of skill in the art to which the present disclosure pertains.

As used herein, the singular forms “a,” “an” and “the” can include the plural forms as well, unless the context clearly indicates otherwise. It will be further understood that the terms “comprises” and/or “comprising,” as used herein, can specify the presence of stated features, steps, operations, elements, and/or components, but do not preclude the presence or addition of one or more other features, steps, operations, elements, components, and/or groups thereof.

The invention comprises, consists of, or consists essentially of the following features, in any combination.

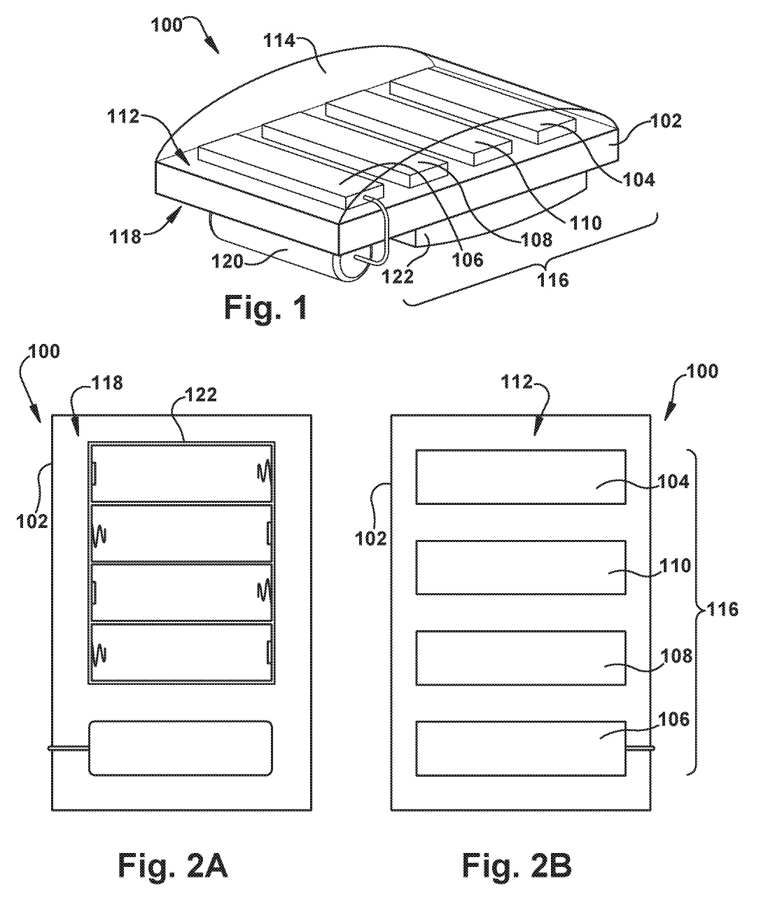

FIG. 1 depicts a communication apparatus 100 of a haptic communication device 144. The communication apparatus 100 includes a circuit board 102, which includes, on a first board surface 112, components 116 such as, but not limited to, a pressure sensor 104, a microprocessor 106, a Bluetooth component 108, and a Wi-Fi component 110. A mass of pressure transmitting material 114 at least partially encases the circuit board 102, including its components 116. The mass of pressure transmitting material 114 may consist substantially of silicone. On a second board surface 118, or any other portion of the circuit board 102, a haptic response motor 120 and a battery unit 122 may be mounted.

FIG. 2A depicts the second board surface 118 of the circuit board 102. A haptic response motor 120 and a battery unit 122 are located on the second board surface 118 of the circuit board 102 and are both electrically connected to the circuit board 102. The battery unit 122 can be powered in any desired manner, such as, but not limited to, one or more replaceable consumer batteries such as AA or AAA.

FIG. 2B depicts the first board surface 112 of the circuit board 102. The microprocessor 106, the pressure sensor 104, the Wi-Fi component 110, and the Bluetooth component 108 may all be located, for example, on the first board surface and may be electrically connected to the circuit board 102. The components 116 may have any suitable configuration and connectivity, as would be understood by one of ordinary skill in the art. The pressure sensor 104 may be, for example, a barometric sensor, a Hall effect sensor, or any other suitable pressure sensor or combination of sensors. The Wi-Fi component 110 and the Bluetooth component 108 may be used for wirelessly transmitting signals from the circuit board 102 of the communication apparatus 100 to another device over a communication network. The Wi-Fi component 110, for example, may wirelessly transmit signals indirectly to another device over the Internet, while the Bluetooth component 108 may wirelessly transmit signals directly to another device over a Bluetooth network and/or indirectly over the Internet. Other communication components, such as ZigBee or Near Field Communication (NFC) components, may be used in place of or in conjunction with the Wi-Fi component 110 and Bluetooth component 108.

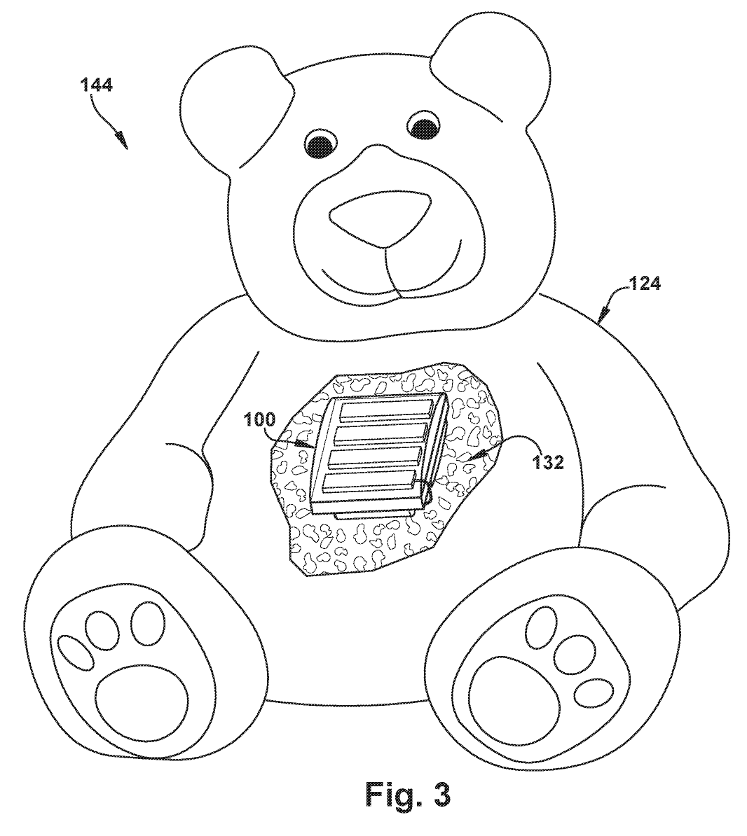

FIG. 3 schematically depicts a haptic communication device 144 including the communication apparatus 100. The haptic communication device 144 may include a flexible outer shell 124. The flexible outer shell 124 may be made of a flexible and/or machine washable material. For example, the flexible outer shell 124 may be made of fabric. The flexible outer shell 124 may be in a form that resembles a toy animal. Optionally, the flexible outer shell 124 may be in a form that includes projections, such as, but not limited to limbs, a torso, and/or a head, that are configured to wrap around a part of a user's body, simulating an embrace or hug surrounding-type interaction with the user by the haptic communication device 144. The flexible outer shell 124 may be in other forms, though will generally be configured such that the flexible outer shell 124 wholly encloses the communication apparatus 100 for many example use environments. The flexible outer shell 124 may include a re-sealable opening through which the communication apparatus 100 may be taken out of and put back into the flexible outer shell 124 for assembly and/or maintenance of the flexible outer shell 124.

The communication apparatus 100, enclosed within the flexible outer shell 124, may be at least partially surrounded by soft stuffing material 132. The soft stuffing material 132 may support the form of the flexible outer shell 124. The soft stuffing material 132 may be of any material that is durable, yet compressible, such as, but not limited to, a polyester material and/or a cotton material—e.g., batting or stuffing.

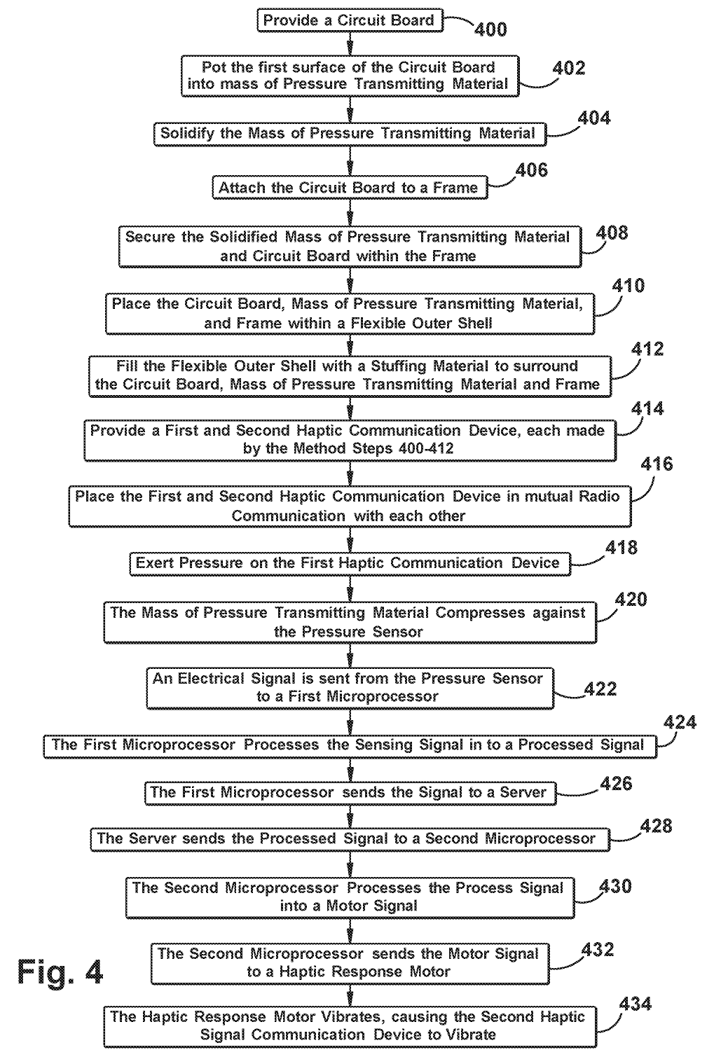

Turning to FIG. 4, action blocks 400-412 describe an example method of making the communication apparatus 100 enclosed within the flexible outer shell 124 of the haptic communication device 144. Action blocks 414-434 describe an example method of using two haptic communication devices 144a, 144b for haptic communication, and will be described later.

In first action block 400, the circuit board 102 is provided, along with the pressure sensor 104, the at least one microprocessor 106, and the at least one haptic response motor 120. The pressure sensor 104, the at least one microprocessor 106, and the at least one haptic response motor 120 are all electrically connected to the circuit board 102, as previously described with reference to FIG. 1. In the second action block 402, the first board surface 112 of the circuit board 102 is potted into a mass of pressure transmitting material 114, such as, but not limited to a silicone material, in fluid form (e.g., a liquid, a suspension, and/or a gel) such that the pressure sensor 104 is at least partially encapsulated by the mass of pressure transmitting material 114. In third action block 404 the mass of pressure transmitting material 114 in fluid form is solidified. This solidification may occur naturally over a period of time, or may be facilitated by heat or airflow.

In fourth action block 406, the circuit board 102, with the mass of pressure transmitting material 114 on the first board surface 112, may be placed in a housing base 600 in order to maintain all components of the communication apparatus 100 together. The housing base 600, depicted in FIG. 6, may be rigid, for example, made of plastic. The housing base 600 may also be of any shape or size such that the circuit board 102 is able to fit within an outer perimeter of the housing base 600.

In fifth action block 408, the circuit board 102, with the mass of pressure transmitting material 114, may be secured onto the housing base 600 by a retainer ring 602, as depicted in FIG. 6, that securely attaches to the perimeter of the housing base 600 such that the circuit board 102, with the mass of pressure transmitting material 114 is securely held between the housing base 600 and the retainer ring 602. The retainer ring 602 may be of any shape or size, relative to the housing base 600, such that the retainer ring 602 may securely attach to the perimeter of the housing base 600.

In sixth action block 410, the circuit board 102, with the mass of pressure transmitting material 114 (and the housing base 600 with the retainer ring 602, when present), is placed within the flexible outer shell 124. In seventh action block 412, the flexible outer shell 124 is at least partially filled with the stuffing material 132 to at least partially surround the circuit board 102, mass of pressure transmitting material 114, and housing base 600 with retainer ring 602, when present.

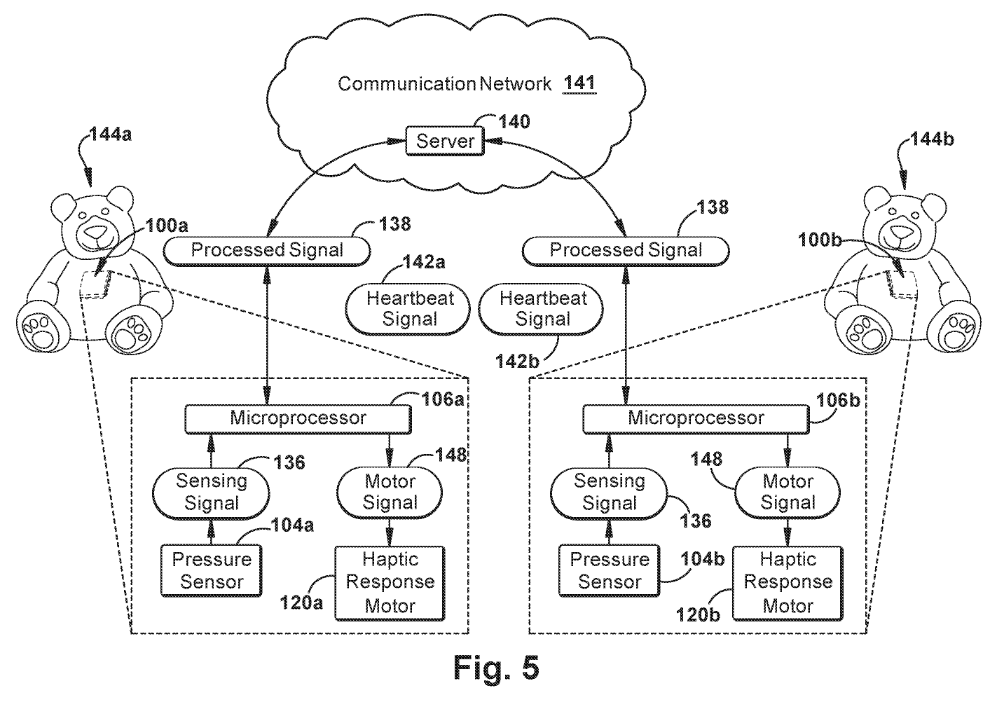

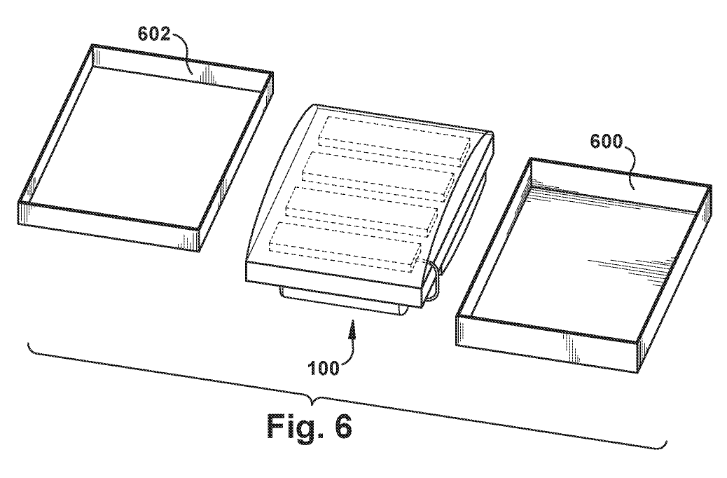

With reference to eighth through eighteenth action blocks 414-434 of FIG. 4, as well as FIG. 5, an example method of remote haptic communication and an associated system are described and schematically shown. In eighth and ninth action blocks 414 and 416, respectively, of FIG. 4, first and second haptic communication devices 144a and 144b, respectively, are provided and are placed in mutual electronic communication with each other.

FIG. 5 schematically depicts an example system of remote haptic communication between two haptic communication devices 144a, 144b that are separated by a distance. This remote haptic communication may be used when two people are separated by a distance, but wish to exchange the symbolism associated with some form of person-to-person haptic communication, such as a hug, a caress, or another type of affectionate or loving touch. This personal communication may be simulated with the example method and system of remote haptic communication disclosed herein, where the actuation of a haptic response in one haptic communication device 144b held by one user in one location, occurs in response to a specific interaction of another haptic communication device 144a with another user in another location. The two haptic communication devices 144a, 144b may have the communication apparatus 100, depicted in FIG. 1, however, the haptic communication devices 144a, 144b may each include the same or different features, structures, and configurations as desired. For example, the flexible outer shell 124 of each haptic communication device 144a, 144b may be of a different form, or made of a different material.

It is also contemplated that each haptic communication device 144a, 144b may be differently configured devices altogether (having different sizes, shapes, materials, colors, weights, or any other physical characteristics), though for most use environments, it is contemplated that each haptic communication device 144a, 144b includes the communication apparatus 100 enclosed within the flexible outer shell 124, such that ambient pressure may be sensed by the communication apparatus 100 in each haptic communication device 144a, 144b. As an example, though, one haptic communication device 144a could be used in conjunction with a smartphone app providing, in a virtual manner, at least some of the functions of a second haptic communication device 144b—therefore, a traveling user could interact with a loved one in much the same manner as described herein without having to have the second haptic communication device 144b physically present.

In tenth action step 418, pressure may be exerted on the first haptic communication device 144a. For example, application of ambient compression force, such as, but not limited to, a hug by a user, on the first haptic communication device 144a may cause the flexible outer shell 124 of the first haptic communication device 144a to compress. This compression of the flexible outer shell 124a reaches the communication apparatus 100a of the first haptic communication device 144a. The transmission of the ambient compression force to the communication apparatus 100a may be facilitated by the soft stuffing material 132a. The transmitted compression force is thus exerted upon the mass of pressure transmitting material 114 of the communication apparatus 100a within the first haptic communication device 144a. In eleventh action step 420, the mass of pressure transmitting material 114 of the communication apparatus 100a compresses on the pressure sensor 104a, thus transmitting the pressure to the pressure sensor 104a encased within the mass of pressure transmitting material 114.

In twelfth action step 422, an electrical signal is sent from the pressure sensor 104a to a first microprocessor 106a of the communication apparatus 100a within the same haptic communication device 144a. This electrical signal may be a sensing signal 136a. In thirteenth action step 424, the microprocessor 106a processes the sensing signal 136a and responsively creates a processed signal 138. In fourteenth action step 426, the microprocessor 106a then sends the processed signal 138 to a server 140 over any suitable communication network 141 such as, but not limited to, wired, wireless, Bluetooth, and/or Internet communication schemes.

In fifteenth action step 428, the server 140 then sends the processed signal 138 to a second microprocessor 106b of a communication apparatus 100b within a second haptic communication device 144b. In sixteenth action step 430, the microprocessor 106b processes the processed signal 138 and responsively creates a motor signal 148b. In seventeenth action step 432, the microprocessor 106b sends the motor signal 148b to the haptic response motor 120b of the communication apparatus 100b within the second haptic communication device 144b. In eighteenth action step 434, upon receipt of the motor signal 148b, the haptic response motor 120b may respond with, for example, vibration. This vibration may be felt by a second user holding the second haptic communication device 144b, thus indicating to the first user that the first haptic communication device 144a has been interacted with by a first user.

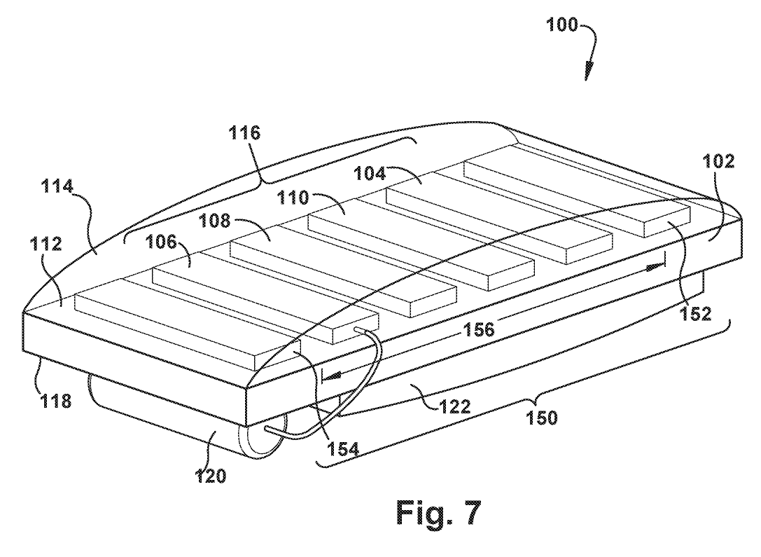

FIG. 7 schematically depicts a multi sensor input 150 of a communication apparatus 100 of a haptic communication device 144. The multi sensor input 150 uses a similar pressure principle as detailed above. Pressure may be exerted on the haptic communication device 144. For example, application of ambient compression force, such as, but not limited to, a hug by a user, on the haptic communication device 144 may cause a flexible outer shell 124 of the haptic communication device 144 to compress. This compression of the flexible outer shell 124 reaches the communication apparatus 100 of the haptic communication device 144. The transmission of the ambient compression force to the communication apparatus 100 may be facilitated by soft stuffing material 132. The transmitted compression force is thus exerted upon the mass of pressure transmitting material 114 of the communication apparatus 100 within the haptic communication device 144. The mass of pressure transmitting material 114 of the communication apparatus 100 compresses on the at least two pressure sensors 152, 154, thus transmitting the pressure to at least two pressure sensors 152, 154 encased within the mass of pressure transmitting material 114.

The multi sensor input 150 compares the pressure value transmitted from the at least two pressure sensors 152, 154 placed at a known distance apart 156. The multi sensor input 150 determines if there is compression from the right side or the left side by comparing the pressure values detected by the at least two pressure sensors 152, 154. The at least two pressure sensors 152, 154 can be placed at opposite ends, the right and left end, of the haptic communication device 144 to detect the pressure differential from a user holding the haptic communication device 144. A different response from the communication apparatus 100, such as a specific haptic response pattern, initiating a Skype call or other communication according to predetermined parameters, or any other desired response may result depending on which pressure sensor 152, 154 detects more pressure. The at least two pressure sensors 152, 154 can include, but are not limited to, barometric sensors.

This system of remote haptic communication is reciprocal, in that communication may be made similarly from the first haptic communication device 144a to the second haptic communication device 144b, or from the second haptic communication device 144b to the first haptic communication device 144a. It is contemplated that both the first and second haptic communication devices 144a, 144b may be compressed simultaneously, to cause a simultaneous response.

In one example feature of the system, when both the first and second haptic communication devices 144a, 144b are compressed simultaneously, the resulting simultaneous response may be actuated in the rhythm of a heartbeat. To effectuate this “heartbeat” response, a heartbeat signal 142a, of a first user, and a heartbeat signal 142b, of a second user, may be provided and transmitted to the respective microprocessors 106a, 106b. The microprocessors 106a, 106b may then use the respective heartbeat signals 142a, 142b when creating the processed signal 138 which is sent to the respective opposite haptic communication device 144a, 144b. The heartbeat signals 142a, 142b may be created, for example, with the use of heartbeat detection devices provided within the haptic communication devices 144a, 144b.

Alternatively, for example, a wearable heartbeat detection device may be worn by the users to wirelessly transmit the heartbeat signals 142a, 142b to the respective microprocessors 106a, 106b. When the heartbeat signals 142a, 142b are processed into the respective processed signals 138 by the respective microprocessors 106a, 106b, the respective haptic response motors 120a, 120b of the opposite haptic communication devices 144a, 144b will receive corresponding motor signals 148 and will communicate a heartbeat-rhythmed response from the respective other user.

In another embodiment, a pre-programmed generic heartbeat rhythm (as opposed to a sensed or otherwise personalized heartbeat) may be pre-programmed and effectuated through the haptic response motor 120a, 120b when the two haptic communication devices 144a, 144b are compressed simultaneously.

Additionally, the intensity of haptic response effectuated by the haptic response motors 120a, 120b may be relative to the intensity of compression applied to the respective other haptic communication device 144a, 144b by a user. For example, a slight compression of haptic communication device 144a may cause a slight vibration in haptic communication device 144b, where a strong compression of haptic communication device 144a may cause a strong vibration in haptic communication device 144b.

This system of remote haptic communication may contribute to a number of beneficial results in a user's emotional wellbeing and sense of physical connectivity to another, remotely located user. For example, when a second user feels a haptic response of the haptic communication device 144b in response to the respective other haptic communication device 144a being interacted with by a first user, the second user may release oxytocin in their brain. Oxytocin is released in a human brain when a human experiences sensations such as, but not limited to, pleasant social or relational interaction with another human being. Accordingly, it is believed that this release of oxytocin is especially likely when the users are in a close social relationship, such as, but not limited to a parent-child relationship, a romantic relationship, or a platonic relationship. This oxytocin release may cause a series of beneficial psychological and physical results, such as, but not limited to relaxation, alleviation from stress and anxiety, and general mood enhancement.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

I claim:

1. A haptic communication device comprising:
a flexible outer shell;
a circuit board wholly encased within the flexible outer shell, the circuit board having at least one pressure sensor located on and electrically connected to a first surface of the circuit board;
a mass of pressure transmitting material wholly encased within the flexible outer shell and at least partially attached to and extending from the first surface of the circuit board, the mass at least partially encasing the at least one pressure sensor;
at least one microprocessor wholly encased within the flexible outer shell and electrically connected to the circuit board; and
at least one haptic response motor wholly encased within the flexible outer shell and electrically connected to the circuit board.

2. The haptic communication device of claim 1, wherein the flexible outer shell is made partially from fabric.

3. The haptic communication device of claim 1, wherein the flexible outer shell includes a plurality of limbs, a torso, and a head.

4. The haptic communication device of claim 1, including a battery unit electrically connected to the circuit board.

5. The haptic communication device of claim 4, wherein the battery unit is attached to a second surface of the circuit board, opposite the first surface.

6. The haptic communication device of claim 1, wherein the haptic response motor is a vibration motor.

7. The haptic communication device of claim 1, including a soft stuffing material disposed entirely within the flexible outer layer and surrounding at least a portion of the circuit board and at least a portion of the mass of pressure transmitting material.

8. The haptic communication device of claim 1, including a Wi-Fi component electrically connected to the circuit board for Internet communication.

9. The haptic communication device of claim 1, including a Bluetooth component electrically connected to the circuit board for communication with other devices.

10. The haptic communication device of claim 1, wherein the mass of pressure transmitting material consists of silicone.

11. The haptic communication device of claim 1, wherein the pressure sensor is a barometric sensor.

12. The haptic communication device of claim 1, including at least two pressure sensors separated by a predetermined distance, each of the at least two pressure sensors being located on and electrically connected to a first surface of the circuit board.

13. A system of haptic communication, the system comprising:
at least two haptic communication devices, each haptic communication device including
a flexible outer shell,
a circuit board wholly encased within the flexible outer shell, the circuit board having at least one pressure sensor located on and electrically connected to a first surface of the circuit board,
a mass of pressure transmitting material wholly encased within the flexible outer shell and at least partially attached to and extending from the first surface of the circuit board, the mass at least partially encapsulating the at least one pressure sensor,
at least one microprocessor wholly encased within the flexible outer shell and electrically connected to the circuit board, and
at least one haptic response motor wholly encased within the flexible outer shell and electrically connected to the circuit board;
a server; and
a communication network configured to transmit signals between at least two of: the at least one microprocessor of each of the at least two haptic communication devices, and the server.

14. The system of claim 13, wherein the communication network includes Wi-Fi connection.

15. The system of claim 13, wherein the communication network includes Bluetooth connection.

16. The system of claim 13, wherein the mass of pressure transmitting material in each of the at least two haptic communication devices is configured to transmit an external pressure on the mass of pressure transmitting material to a respective at least one pressure sensor of the haptic communication device.

17. The system of claim 16, wherein the at least one pressure sensor of each of the at least two haptic communication devices is configured to send a sensing signal to the at least one microprocessor of the respective haptic communication device.

18. The system of claim 17, wherein the at least one microprocessor of each of the at least two haptic communication devices is configured to generate a processed sending signal responsive to at least one sensing signal, the processed sensing signal being sent to the server over the communication network.

19. The system of claim 17, wherein the at least one microprocessor of a selected haptic communication device is configured to receive a motor signal from the server over the communication network, each motor signal being generated by the server responsive to a sending signal from another haptic communication device.

20. The system of claim 17, wherein the at least one microprocessor of each of the at least two haptic communication devices is configured to send a processed motor signal to the at least one haptic response motor of a respective haptic communication device.

21. The system of claim 20, wherein the at least one haptic response motor is a vibration motor configured to vibrate in response to receipt of the processed motor signal.

22. A method of providing a haptic communication device comprising:
providing a circuit board including:
at least one pressure sensor located on and electrically connected to a first surface of the circuit board,
at least one microprocessor electrically connected to the circuit board, and
at least one haptic response motor electrically connected to the circuit board;
potting the first surface of the circuit board into a mass of silicone material in fluid form, such that the at least one pressure sensor is at least partially encapsulated by the mass of silicone material;
solidifying the mass of silicone material;
attaching the circuit board to a housing base;
securing the solidified mass of silicone material and circuit board within the housing base by attaching a retainer ring around the mass and into engagement with the housing base;
placing the circuit board, mass of silicone material, and housing base within a flexible outer shell; and
at least partially filling the flexible outer shell with a stuffing material to at least partially surround the circuit board, mass of silicone material, and housing base with stuffing material within the flexible outer shell.

23. The method of claim 22, wherein the housing base is made of plastic.

24. The method of claim 22, including:
providing a battery pack secured to the housing base and electrically connected to at least one of the pressure sensor, the microprocessor, and the haptic response motor; and
providing electrical power to at least one of the pressure sensor, the microprocessor, and the haptic response motor with the battery pack.

25. A method of distance haptic communication, the method comprising:
providing a first haptic communication device and a second haptic communication device, the first and second haptic communication devices being made by the method of claim 22;
placing the first and second haptic communication devices in mutual electronic communication;
exerting pressure on the first haptic communication device;
causing the mass of silicone to compress against the pressure sensor;
sending an electrical signal from the pressure sensor to a first microprocessor;
processing the sensing signal into a processed signal by the first microprocessor;
transmitting the processed signal to a server from the first microprocessor;
receiving the processed signal from the server by the second microprocessor;
processing the sensing signal into a motor signal by the second microprocessor;
causing the haptic response motor within the second haptic communication device to vibrate; and
causing the second haptic communication device to vibrate.

26. A method of claim 25, wherein simultaneous compression of the first and second haptic communication devices causes a simultaneous response by the respective haptic response motors.

27. A method of claim 26, wherein the simultaneous response comprises the respective haptic response motors mimicking a heartbeat of a respective user of the first and second haptic communication devices.

28. A method of claim 25, wherein a vibration of at least one haptic communication device causes a hormone release by a user.

29. A method of claim 28, wherein the hormone release consists of an oxytocin release.

30. A method of claim 25, including a multi sensor input which includes at least two pressure sensors wherein the multi sensor input compares the detected pressure from the at least two pressure sensors.
